(19) United States
(12) Patent Application Publication
(10) Pub. No.: US 2005/0261927 A1
(43) Pub. Date: Nov. 24, 2005

(54) System and method for valuing intellectual property

(76) Inventors: Mark R. Bilak, Sandy Hook, CT (US); Gary C. Dauser, Pleasant Valley, NY (US); Karen P. Madden, Poughquag, NY (US); Kris V. Srikrishnan, Wappingers Falls, NY (US)

Correspondence Address: Jay H. Anderson;IBM Corporation, Dept. 18G, Building 300-482, 2070 Route 52, Hopewell Junction, NY, 12533, US

(21) Appl. No.: 10/853,381

(22) Filed: May 24, 2004

(51) Int. Cl. G06F 17/60

(52) U.S. Cl. 705/1

(57) ABSTRACT

A method, system, and machine-readable medium having instructions recorded thereon are provided for valuing a current intellectual property (IP) transaction. The method includes providing IP data, financial data, and license data, the license data representing transactions other than the current IP transaction. A license value is obtained by referring to the license data. The value of the current IP transaction is determined by adjusting the license value in relation to the IP data, the financial data, and at least one of: i) trend data and ii) at least one quality factor.

### BACKGROUND OF THE INVENTION

The present invention relates to systems and methods for valuing intangible assets such as intellectual property.

Intellectual property (hereinafter, “IP”) plays an important role in today's international economy. The establishment and protection of IP rights help to protect not only investments made in creating the IP, but other investments made to market goods which incorporate IP. However, it is frequently not enough to develop and protect one's own IP. The ability to bring one's products to the market also requires access to the IP rights of others. Accordingly, a seller, manufacturer, or importer of goods or services must enter into IP transactions in order to enter and remain in the market.

A frequent stumbling block to entering transactions is reaching a valuation for the IP that is acceptable to all of the involved parties. Like real property, IP is unique, in that no two pieces of IP or even collections of IP are ever the same, such that the value would be the same for one and all. In addition, the valuation of IP is performed in a much different way from that of real and personal property. Unlike real and personal property, which are tangible, such that the value is determined in large part by visual and other sensory inspection, IP is intangible, such that the value of any one particular piece requires detailed study and analysis.

While IP can be bought and sold like other property, IP is frequently licensed, such that the owner retains title, and merely gives others permission to use the IP or enjoy the rights under the IP in certain ways. Often, a large collection of IP having many individual pieces is licensed in the aggregate by one owner, for example, a manufacturer, to another IP owner, in exchange for licensing another large collection of IP belonging to the other owner. Such license is known as a cross-license. In such transactions, every party must reach a valuation of the IP which it can accept as equitable, or else the transaction will not be entered. The articles by R. Pitkethly, “The Valuation of Patents”, The Said Business School, University of Oxford and Oxford Intellectual Property Research Centre, 1997, and M. J. Mard “Intellectual Property Valuation Challenges,” The Licensing Journal, May 2001, pp. 25-30, describe a variety of approaches for use in valuing IP. Among such approaches are: cost-based methods, market-based methods, methods based on projected cash flows, discounted cash flow (DCF) methods allowing for the time value of money, DCF methods allowing for the riskiness of cash flows, DCF-based decision tree analysis (DTA) methods, option pricing theory (OPT) based methods, binomial model (B-M) based methods, stock market-based methods, and patent renewal data-based methods.

Notwithstanding these various approaches for valuing IP, heretofore, there has not been a reliable way of valuing a collection of IP that each party to a transaction can accept as being equitable. Particularly where the renewal of an existing IP license is negotiated, there has not been a method which both parties can accept as determining a demonstrably equitable valuation. Too often, the factors considered in making the IP valuation are accused of being too heavily in one party's favor. For example, this occurs where assumptions are made concerning the forward-looking value of a single IP asset. Notwithstanding the above, the value of an IP asset is “relative”, in that it depends on the intended receiver and intended use.

Hence, it would be desirable to provide a method of valuing IP which takes into account multiple parameters, and applies them consistently to the IP contributions of both parties to a transaction. Particularly in situations where a prior license between parties is negotiated for renewal, it would be desirable to demonstrate, using consistently applied criteria, the relative contributions of each party, and to relate current circumstances to those which were present when the prior license was entered.

### SUMMARY OF THE INVENTION

According to an aspect of the invention, a method is provided for valuing an intellectual property (IP) collection of a first party in a transaction involving a grant by the first party of at least one of rights and immunities to a second party. Such method includes a) estimating an amount of revenue of the second party to which the IP collection is deemed to apply; and b) placing a value on the IP collection based on the estimated amount of revenue and information including one or more of the following: i) IP trend factor based on a change in the IP collection, ii) revenue trend factor based on change in revenue of the second party to which the IP collection is deemed to apply, and change in revenue of one or more entities having revenue in the same industry as the second party, iii) type of industry to which the IP collection applies, iv) prior licensing data involving the IP collection, and v) IP and revenue quality factors.

According to another aspect of the invention, a method is provided of valuing an intellectual property (IP) transaction for licensing a first IP collection of a first party to a second party, and for licensing a second IP collection of the second party to the first party. Such method includes 1) placing a value on the first IP collection by dividing the first IP collection into m distinct first subcollections. For each of the m first subcollections, the following are performed: a) estimating an amount of revenue of the second party to which the selected first subcollection is deemed to apply, and b) placing a value on the selected first subcollection based on the estimated amount of revenue and information including one or more of the following: i) IP trend factor based on a change in at least the first subcollection, ii) revenue trend factor based on change in revenue of the second party to which the first subcollection is deemed to apply, and change in revenue of one or more entities having revenue in the same industry as the second party, iii) type of industry to which the selected first subcollection applies, iv) prior licensing data involving the selected first subcollection, and v) IP and revenue quality factors.

In the method according to such aspect, a value is placed on the second IP collection by dividing the second IP collection into n distinct second subcollections. For each of the n second subcollections, the following are performed: a) estimating an amount of revenue of the first party to which the selected second subcollection is deemed to apply, and b) placing a value on the selected second subcollection based on the estimated amount of revenue and information including one or more of the following: i) IP trend factor based on a change in at least one of the second subcollection and the second IP collection, ii) revenue trend factor based on change in revenue of the first party to which the second subcollection is deemed to apply, and change in revenue of one or more entities having revenue in the same industry as the first party, iii) type of industry to which the selected second subcollection applies, iv) prior licensing data involving the selected second subcollection, and v) IP and revenue quality factors. The values placed on the first and second IP collections in steps I and II are then combined to determine a relative valuation between the first and second IP collections.

According to a preferred according to an aspect of the invention, the first IP collection is further valued based on a weighted change per time interval in the licensable IP. Preferably, the first IP collection is further valued based on a trend in growth of the applicable revenue. Preferably, the first IP collection is further valued based on a weighted change per time interval in the applicable revenue.

According to yet another preferred aspect of the invention, the first IP collection is further valued in accordance with a value placed by an industry on an industry category of IP to which the first IP collection belongs.

Preferably, the first IP collection is further valued based on a revenue quality factor which adjusts for a type of revenue included within the applicable revenue. According to a further preferred aspect of the invention, the first IP collection is further valued based on an IP quality factor which adjusts for proximity to saturation by a number of IP pieces in a specific category of the first IP collection.

According to still another preferred aspect of the invention, a method of valuing the intellectual property transaction further includes valuing a second intellectual property (IP) collection having a plurality of pieces for which at least one of rights and immunities are to be granted in the current transaction to the second party by the first party. In such case, the second IP collection is valued based on: a) an amount of applicable revenue to which the second IP collection is deemed to apply, b) a value placed on a second category of IP including the second IP collection by the second party, and c) a value placed by the first party in a transaction other than the current transaction on at least one of the second IP collection and the second category of IP.

According to yet another preferred aspect of the invention, a method is provided for valuing an intellectual property transaction which includes valuing a first intellectual property (IP) collection having a plurality of pieces for which at least one of rights and immunities are to be granted in a current transaction to a first party by a second party. Valuing of the first IP collection is performed based on: a) an amount of applicable revenue to which the first IP collection is deemed to apply, b) a value placed on a first category of IP including the first IP collection by the first party, and c) a value placed by the second party in a transaction other than the current transaction on at least one of the first IP collection and the first category of IP.

According to a yet another preferred aspect of the invention, the other transaction includes a previous transaction between the first and second parties at least partly including the first IP collection. According to another preferred aspect of the invention, the first IP collection is further valued based on a trend in growth of licensable IP held by the second party.

### BRIEF DESCRIPTION OF THE DRAWINGS

FIG. 1 is a schematic diagram of a system for valuing IP according to an embodiment of the invention;

FIG. 2 is a diagram illustrating a method of valuing IP according to an embodiment of the invention.

FIG. 3 is a graph illustrating a weighted cumulative distribution function (cdf) utilized in valuing IP according to an embodiment of the invention.

FIG. 4 is a diagram illustrating determination of relative financial and IP trend positions between the parties to an IP transaction

FIG. 5 is a graph projecting future valuations of an IP transaction.

### DETAILED DESCRIPTION

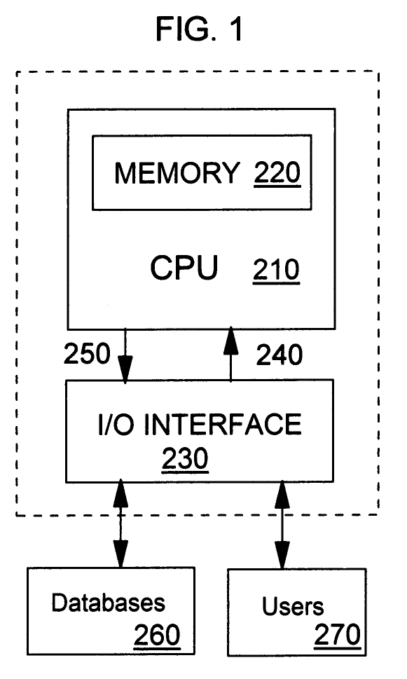

A system, a method, and a machine-readable medium are provided herein for valuing intellectual property (IP). With reference to FIG. 1, an overview of a system for valuing IP will now be provided, followed by a description of operation, including principles of valuing IP according to embodiments of the invention. As shown in FIG. 1, a system for valuing IP includes a central processing unit (CPU) 210 provided with a memory 220. The CPU 210 may include a single processor or a plurality of processors arranged to execute instructions of a program in a parallel or semi-parallel manner. An input output (I/O) interface 230 is provided for inputting a program including instructions and data to the CPU 210 and for outputting the results of executing a program. The I/O interface 230 preferably includes one or more types of interfaces to removable digital storage media such as a magnetic disk, magneto-optic disk, read/write and/or read only optical disc, digital tape, removable disk drive and/or removable solid state memory such as a portable memory card or other digital storage medium. In addition to or in place thereof, the I/O interface preferably includes a network interface such as a modem or network adapter card for permitting transfer of information to and from a network. The I/O interface 230 may also include a display for outputting information to and/or inputting information from a user 270. The I/O interface 230 may additionally include one or more user interface devices such as a keyboard, mouse, speaker, joystick, scanner, printer, etc. and the like. To the extent that any of the above described types of removable storage media are present in the I/O interface, a program containing a set of instructions that is stored in such removable storage medium can be transferred as input 240 between the I/O interface 230 and the CPU 210. In addition to the program, a set of data to be operated upon by the instructions is also input over the I/O interface 230, e.g. from databases 260. Once the program and the data set to be operated upon have been loaded into the CPU 210, the CPU then executes the set of instructions of the program relative to the data and provides output 250 to the I/O interface 230 connected thereto.

In an embodiment, a program containing instructions for performing a method according to an embodiment of the invention is stored on one or more removable storage media to be provided to the I/O interface 230 and loaded into the CPU 210. Alternatively, the program containing the instructions is transferred from a storage medium such as a memory of one or more computers or other storage devices of a network to a modem, network adapter or other communication device of the I/O interface 230 and further transferred therefrom to the CPU 210. After the CPU 210 receives and loads the program into memory, the program is then executed relative to the set of data provided to the CPU 210. In such way, a method of valuing an intellectual property transaction is performed according to an embodiment of the invention.

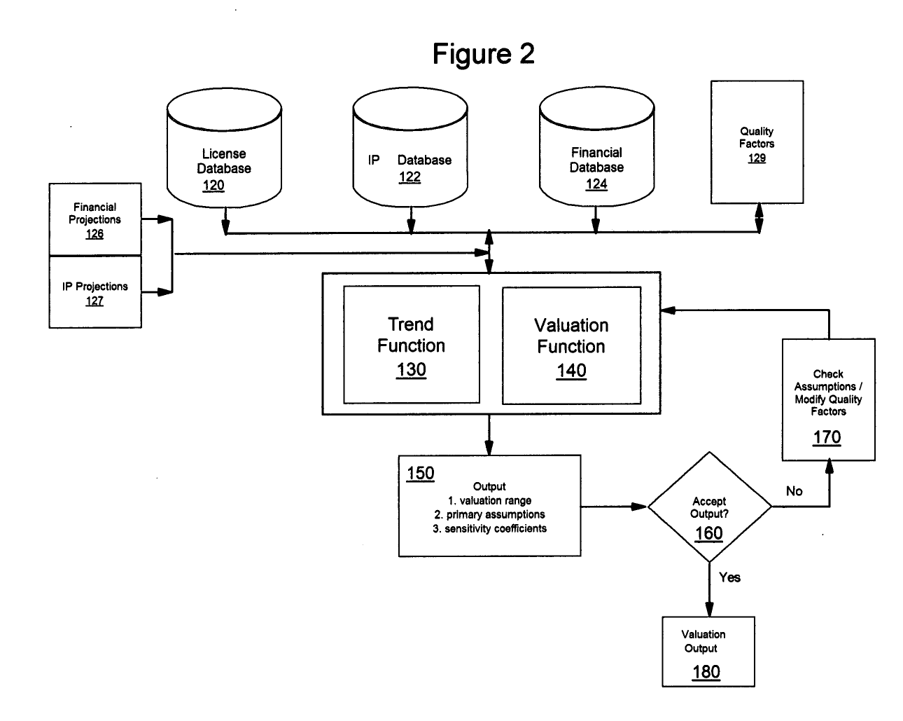

With reference to FIG. 2, an overview of the principles of a method of valuing IP according to an embodiment of the invention will now be provided. As depicted in FIG. 2, input is available from a variety of sources including databases. The value of an IP transaction, such as a licensing transaction, is typically based on many inputs including, but not limited to IP licensing data, IP asset data, product or financial data, any future projections stemming from one or more of the above, and a set of other factors referenced herein as quality factors, which will be described in detail below. Alternatively, only a subset of the factors described above may be considered in valuing a transaction. A few examples of inputs considered in valuing an IP transaction are illustrated in FIG. 2. Data regarding prior transactions is available from License database 120. Data regarding the amount, characteristics, and growth of IP is available by consulting an IP database 122.

Data from these databases, together with data obtained from a financial database 124, are provided as input to a Valuation Function 140, along with financial projections 126, IP projections 127, and quality factors 129 for making a valuation of the transaction. Data from the above-described databases and financial and IP projections and quality factors are also input to a Trend Function 130 for determining trends in the growth (or shrinking) of IP available for licensing from one point in time to another, and trends in the growth (or shrinking) of revenue to which a given set of IP applies.

Thereafter, at block 150, based on the trend and valuation information that are output from the Trend Function 130 and Valuation Function 140, a range of benefit values is assigned to the transaction. In addition, a set of primary assumptions and sensitivity coefficients relating to the transaction are provided. At block 160, a decision is made whether the output is acceptable. If the output is not acceptable, then, in block 170, the assumptions and any other inputs provided to the Trend and Valuation Functions are rechecked and modified, if necessary. Input in the form of Quality Factors may also be modified at this step, after which the rechecked or modified inputs are submitted to the Trend and Valuation Functions again. Thereafter, the outputs of the Trend Function 130 and Valuation Function 140 are provided again at block 150. At block 160, if a decision is made to accept the output, a valuation setting forth a range of benefit values available from the transaction is provided at block 180, together with a set of assumptions upon which the valuation is made.

In an illustrative embodiment, the valuation is performed in support of a licensing transaction. By basing the valuation on known quantities such as financial data and IP portfolio strength, uncertainty and variability are reduced when determining the value of a license. In addition, by utilizing past performance and forward projections, an equitable, consistent and accurate value can be determined for the transaction.

A more detailed description of the various inputs used in making a valuation will now be provided. The License Database 120 contains information regarding prior IP transactions including IP license agreements. The License Database ideally contains information regarding prior IP transactions including licensing agreements between at least one party to the current transaction and many other parties, with respect to any form of IP. Information regarding prior IP transactions between the one party and the other party to the current transaction should also be available in the License Database. A series of fields are provided, including, in one embodiment, the name of the licensee, the licensee's business segments, value of license, term of license, type of license granted (e.g. patent, copyright, technology, trademark, or any combinations thereof) and field of license are contained in the database for each record (license agreement). Other fields not listed herein, which relate to the basis of prior IP transactions including licensing agreements, may be contained within the License Database and are within the scope of this invention. When there are no previous transactions between the two parties to the current transaction, the License Database typically contains information regarding the business segments of the other party, and will have pointers to information regarding transactions involving other similarly situated existing licensees.

IP database 122 contains information relating to intellectual property, such as patents, trademarks, design or other IP related matters. Preferably, the database will also contain information relating to patents used for patent licensing. As mentioned, each database preferably contains one or a plurality of fields. In the IP database, the fields are varied depending upon which IP segment is intended. For example, fields relating to patents may include information about an assignee, patent number, application number, primary classification (US Class, or Intl. Class), secondary classifications, number of forward references, number of backward references, number of claims (and type), geography (where filed and issued), file date, issue date, type (design or utility), family tree (continuation, divisional) and the term of the patent are contained in the database for each record. These fields can be expanded or altered and modified to provide as little or as much information as desired.

Financial database 124 contains financial information relating to entities (e.g., individuals, corporations, government, etc.) involved in past, present, and desired future transactions. Financial database 124 contains revenue data for a group of entities of interest, and desirably contains data for most, if not all, the companies listed in either the License Database 120, the IP database 122 or both. The Financial Database 124 desirably contains specific information regarding entities within specific industries (e.g. computers). Desirably, the Financial Database 124 has fields in each record listing the entity name, total revenue, gross profits, net income, revenue by business segment (e.g. portable computers, desktop computers, servers, etc.), revenue by geography segment (by country and/or region), revenue by business and geography segments and quarter and/or year. The information in the Financial Database is dynamic and is frequently updated, every day, every quarter and/or whenever new revenue information becomes available for a company. Preferably, the Financial Database 124 also includes links to real-time sources of information such as websites of entities involved in past or present transactions and secondary sources of information such as commercially available financial databases.

Quality Factors 129 are used to weight the information provided in the License Database 120, the IP Database 122 and the Financial Database 124. The purpose of the quality factor is to weight raw IP data (e.g., patent data) or financial data according to qualitative factors to a point in which their contribution to a valuation equation appears more representative. In a preferred embodiment, for example, a quality factor for patents is a Value Saturation Point (hereinafter Q_{VSP}). Q_{VSP} represents the point (i.e. number of patents) at which the value of a licensor's portfolio of IP in a particular class or area has saturated. What is meant by saturation is the point above and beyond which a licensee derives little to no additional value for licensing its patents. With reference to patents, quality factors Q_{VSP} are desirably determined for a particular class (e.g. US Class 257), a group of classes, and a field (e.g. those classes relating to semiconductor technology). Q_{VSP} can be determined (e.g. modeled) in a number of different ways. For example, a higher quality factor may be assigned when it is widely known that a company has been a technical leader, being first to the market or a manufacturer of leading edge products of a particular category, and has technical publications, and patents scoring high in citation reports. Q_{VSP} is desirably broken down to subcategories of products. For example, personal computers within the category of computers and display drivers and communications adapters within the category of semiconductor chip manufacturing.

Similarly, quality factors for financial data may be assigned to reflect the source of income in a particular manner or by a particular category. For example, a company that derives its income from manufacturing of a product line such as discrete semiconductor devices may have only a small fraction of income potentially at risk to patents, whereas a different company that derives most of its income from an advanced product or product line may have a greater need for a particular set of patents. Quality factors take these differences into account in weighting the revenue of a particular entity according to the various categories and their respective qualitative assessments. When insufficient or unreliable information exists for making a qualitative assessment of the IP or financial data in a particular category, a default value of “1” is assigned, so as not to affect any value that is multiplied by the factor.

Data from the IP Database 122, Financial Database 124 and Financial and/or IP Projections 126, 127 may be used to determine Q_{VSP}, as well. For example, Q_{VSP} may be determined by modeling the number of patents issued (or filed) in a certain class (e.g. US Class 257) assigned to a certain group of entities (e.g. top 10 semiconductor companies) over some period of time (T). In such a case, several approaches may be used to calculate the actual value of Q_{VSP} such as: (1) average number of patents issued during T, (2) average number of patents filed during T, (3) cumulative probability distribution function (CDF) of the number of patents issued during T, (4) CDF of the number of patents filed during T, (5) weighted average (e.g. by U.S. revenue) number of patents issued during T, (6) weighted average number of patents filed during T, (7) weighted CDF of the number of patents issued during T or (8) weighted CDF of the number of patents filed during T.

In a preferred embodiment, a weighted CDF is used. In an example, the Q_{VSP} is determined as a weighted CDF for all patents whose primary class is related to a particular technology such as semiconductors. In a particular example, the IP Database 122 is accessed to determine a list of patents issued to the top 10 worldwide semiconductor manufacturers, the identities of which are established by data from the Financial Database 124, for example. The accessed data is analyzed to determine the value of Q_{VSP} for semiconductor-related patents, in this example. In another example, patent data is weighted by revenue derived from a particular country. For example, U.S. revenue is considered for valuing U.S. patents. In making such determinations, the time period (T) over which the patent data or financial data are to be modeled is selectable, be it only for the previous year or portion of a year, or for any of several longer periods, e.g. over the past 10 years.

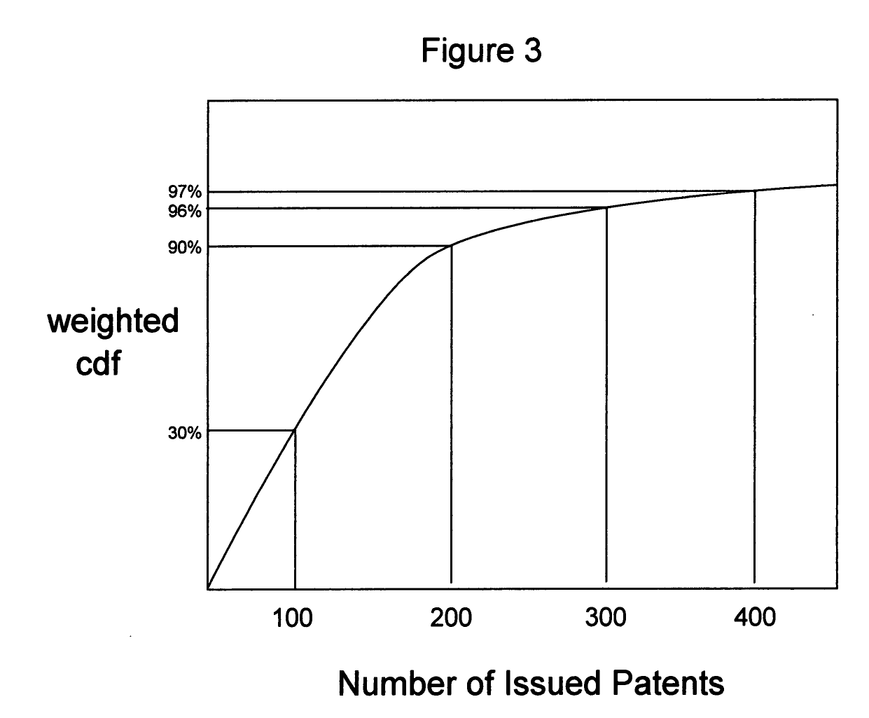

One of the methods to determine a weighted CDF is illustrated graphically in FIG. 3. Referring to FIG. 3, as the number of available licensable patents in a particular category such as a particular class or field increases, the value of the patents begins to level off. With increasing numbers of patents, the value eventually reaches a final 100th percentile value at which an additional patent adds no further value to the portfolio. In such example, the portfolio is considered to be “saturated”. However, there is choice over which point on the curve that “saturation” is deemed to occur. For example, the 90th percentile can be deemed to be the saturation point, in which case the value of Q_{VSP} is 200 patents. Consequently, any assignee with more than 200 patents in this group would receive little to no additional value credit for the number of patents above the 200 point.

Certain patents may also be identified as “golden patents”. These are basic or pioneering patents that are of particular value to a transaction. The saturation point is determined without reference to these patents because their inclusion in the formula may alter the situation, and provide additional revenue or cost to a particular transaction.

Quality factors can include other elements other than saturation information. Other examples of quality factors are a patent-scaling factor (hereinafter Q_{PSF}), and a revenue-scaling factor (hereinafter Q_{RSF}). Q_{PSF} and Q_{RSF} can be calculated or estimated in a number of ways and represent factors to be applied to the value of an entity's patent portfolio and revenue, respectively. Q_{PSF} and Q_{RSF} may be any value greater than zero. Q_{PSF} and Q_{RSF} enable patent and revenue data, respectively, to be scaled with respect to each other and in light of other considerations such as patent filing, issuing trends, and revenue and growth trends. Other examples of quality factors include factors relating to the number of forward and/or backward citations for a particular patent or groups of related patents (hereinafter Q_{FC}/Q_{BC}). In a preferred embodiment, the IP data or the financial data or both are weighted according to the specific circumstances of the negotiations and the transaction to be entered.

Financial Projections 126 and IP Projections 127 are based on any data useful to their determination. The IP and Financial Databases previously described provide backward-looking information. These projections provide forward-looking information. These projections can be used to determine Quality Factors and/or to make general financial or IP projections within a certain technology and/or business segment. Specific financial and IP projections can also be provided regarding each party to the transaction. Projections are determined by any one or several means, such as through competitive analysis techniques or external input from databases, such as those maintained by the United States Patent & Trademark Office (USPTO), Delphion, Gartner, Hoovers, Dataquest or other similar sources.

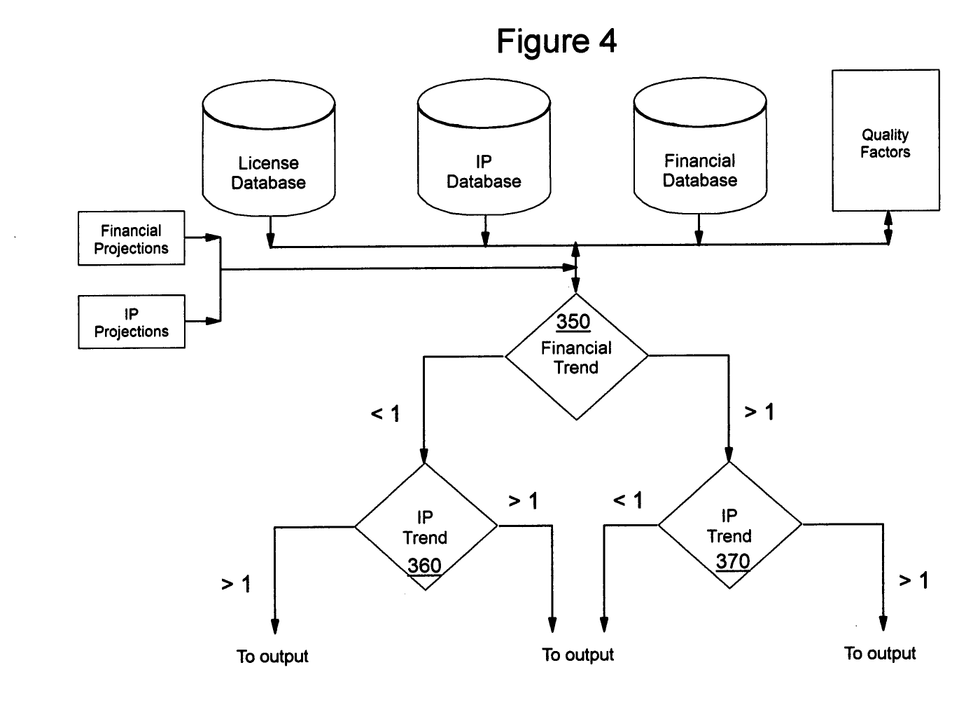

FIG. 4 illustrates use of the Trend Function to predict future IP and financial results of each party to the proposed transaction relative to the other, based on data representing past and present results. An IP Trend value and a Financial Trend value are determined for each party to the transaction, these values representing the growth (or decline) of IP acquisition and applicable revenue over a specified period of time. The value of the IP Trend is positive when available licensable IP is growing, and the value is negative when available licensable IP is declining. For example, if a party A (an entity such as a corporation or an individual, hereinafter simply “A”) acquired 20 patents in the past 5 years and obtained 30 patents per year in the last two years, the trend is increasing and is positive. The IP Trend value for A would then be calculated as 1.5. Doing the same analysis for party B (another such entity, hereinafter, simply “B”), a similar trend ratio can be obtained. By way of caution, trends that result from insignificant activity (for example, the acquisition of less than 10 patents) are to be treated as unchanging and assigned a trend value of 1. Then, the IP Trend for a first party, e.g. party “A”, the “licensee” is divided by the IP Trend for the second party, e.g. party “B”, the “licensor” to obtain a relative IP Trend value representing the trend of IP acquisition by party A in relation to the IP acquisition trend of party B. A similar computation is performed to obtain a relative Financial Trend value based on a financial trend of party A in relation to a Financial Trend of party B over the same time interval.

After these relative IP Trend and Financial Trend values have been determined, their values are tested in order to sort the relative trends between the parties as falling into four different categories. For example, with reference to FIG. 4, at decision block 350, it is determined whether the relative Financial Trend value between the parties is greater than or less than unity. If this value is greater than one, then the IP acquisition of party A is growing faster than the IP acquisition of party B. Alternatively, if the availability of licensable IP of A is actually declining, then a value greater than one indicates that the available IP of A is declining more slowly than that of B. Conversely, when the value of the relative Financial Trend is less than one, then the IP acquisition of party A is growing more slowly than the IP acquisition of party B. Alternatively, if the availability of licensable IP of A is actually declining, then a value of less than one indicates that the available IP of A is declining more rapidly than that of B.

After calculating financial trends for each party, the relative Financial Trend is determined and categorized as indicated. IP trends are also calculated for each party, and a relative IP Trend value is determined, in a manner like that described above for determining the Financial Trend value. The outcome of decision block 350 is tested as to the value of the relative IP Trend, at decision blocks 360 and 370. At decision blocks 360 and 370, the relative IP Trend value is tested in a way similar to that described above for testing the relative Financial Trend value, such that one of four outcomes results: namely, A/B financial and IP trends both greater than 1; A/B financial and IP trends both less than 1; A/B financial trend greater than 1, A/B IP trend less than 1, and A/B financial trend less than 1, A/B IP trend greater than 1.

Ideally, in this example, different types of Trend Functions are employed depending on whether the license agreement is a “renewal” where a prior transaction was conducted, e.g., a license agreement or, rather, a first such agreement between the parties. In case of “renewal”, the relevant Trend Functions are the IP and financial income trends of the licensee and licensor, their relative trend directions and values. The Trend Function for IP of interest for this calculation is the ratio of IP Trend values. If A has an IP Trend value of 1.5, and B has an IP Trend value of 2, then Trend Function (A/B) is 1.5 divided by 2, namely 0.75, which is less than one. When the Trend Function has a value of less than one, this means, that compared to the previous licensing transaction, B is making a greater contribution to the IP relative to A than it did so when the prior licensing transaction was entered. However, the IP contribution of A relative to that of party B, measured in absolute terms, could still be larger. The absolute contributions of A and B are assessed by the Valuation Function. Similarly, when the Trend Function has a value of greater than one, this means that A is making a greater contribution to the IP relative to B than it did so when the prior license was entered.

A similar analysis can be made using revenue from the product area corresponding to the IP area. For example, the product could be semiconductors, displays, PCs etc. Again, any insignificant changes in the revenue should be considered as non-changes, in which the Trend Function value is considered to be “1”. The cut-off value for this determination should be set at a high enough threshold to make trends “genuine”, and not mere transient variation or “noise”. For example, in the case of semiconductors or displays, less than a five million dollar change can be considered insignificant.

In case of a “first time” negotiating scenario, in which there is no comparable prior license agreement between the parties, the Trend Functions are to be viewed in conjunction with current ‘absolute’ values in deciding a modified value of the Trend Function. The previous example of B and A can be reapplied here to establish results. B has an IP trend of 2.0 but has the actual current patent issue of 20. A, while having an IP trend of 1.5, might have been issued only 30 patents. In order to decide in which case it belongs, the current actual patents are multiplied by the trend ratio and compared to one another. In this case, the Trend Function (A/B) for IP will be 30×1.5/20×2.0=1.125, versus 0.75 if the actual patents were not considered. This means the Trend function (A/B) is modified to select patent value trend and take into account both actual patents and trends. The company that has a large number of patents already issued will benefit as if it has a higher Trend Function. In the same way, the company that has higher current revenue will find the revenue trend ratio modified.

Valuation Function

The “Valuation Function” 140 depicted in FIG. 2 is provided to verify prior licensing history. Many factors may be considered, but at its simplest form, the value of a particular asset such as a license is determined from IP data input from the IP database, license data input from the License Database, financial data input from the financial database), financial and IP projections, and Quality Factors, as discussed above. In addition, the valuation models provided herein are subject to modification according to the outputs of the Trend Function. Without this modification, the license value may be based wholly upon past and present data. By utilizing the Trend Function, the license value as determined by the Valuation Function can be projected forward using the output of the Trend Function. As such, a value for entering a transaction such as a license agreement can be determined based upon solely past/present data (Valuation Function only) or as also based on future trends, using outputs of the Valuation Function, modified by the Trend Function, or both.

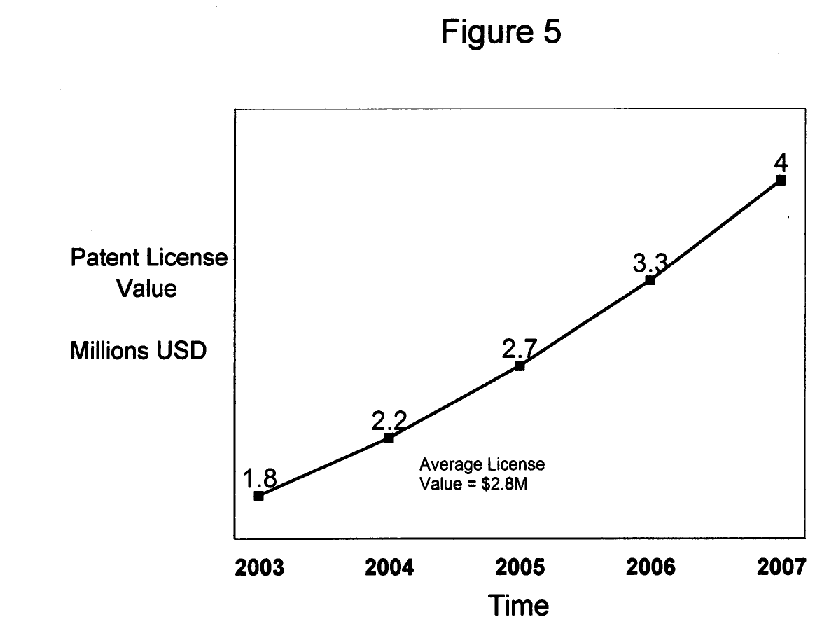

FIG. 5 is a graph illustrating this concept, in which a simple linear regression projects the Valuation Function going forward, over a period of years, based on the outputs of the Trend Function. This enables the parties to understand that value of the transaction at a future point in time and to determine the effects, including costs and benefits, of delaying the signing of an agreement. In a hypothetical scenario illustrated in FIG. 5, the Valuation Function determines a value of $1.6 million for a license agreement signed in the year 2002. This value is based solely upon past and present data. Using the Trend Function, the license value is projected forward five years through the year 2007. This allows the parties to observe what the same license agreement would be worth, if signed at a later point in time (i.e. the cost or benefit of delaying). As illustrated in FIG. 5, the value of the license increases to $4 million by the year 2007 with an average value of $2.8 million over the five-year period.

The Valuation Function can be used to address two different scenarios, namely: (1) there is no prior licensing history between the negotiating parties; and (2) there is prior licensing history between the negotiating parties. In addition, two or more sub-scenarios may exist for each scenario. The two cases within each scenario are: (a) a one-way license, and (b) cross-license. Other types of licenses may also be included such as multi-party licenses, etc., when more than two parties are involved, or to address specific situations. However, in this particular example, for ease of description, two sub-scenarios are illustrated.

As in the above example, a transaction involves party A and party B, where A and B are individuals, corporations or any other entities. The outputs from the Trend Function are provided to the Valuation Function. The Valuation Function addresses all the outputs from the Trend Function which are (1) both the Financial Trend (F_{T}) and IP Trend (IP_{T}) are in party A's favor; (2) F_{T} is in party A's favor and IP_{T} is in party B's favor; (3) Both F_{T} and IP_{T} are in party B's favor; and (4) F_{T} is in party B's favor and IP_{T} is in party A's favor.

In its simplest form, the value of a license is determined by IP data input from the IP database, license data input from the license database, financial data input from the financial database, financial and IP projections, and one or more Quality Factors, as discussed above. For the purpose of the present example, consider that A is the licensee while B is the licensor in the negotiation. In addition, the exposed revenue, i.e., the revenue at risk under the proposed license is used as the financial data input, while issued patents constitute the IP data. The Quality Factors are set to one and the value of the license, K_{IV}, or the typical industry license value for a similar license (e.g. same field, term, etc.) is set to be around $10 million.

The following embodiments are illustrations of some of the methods one can use to value an IP licensing transaction between two parties.

1. No Licensing History Exists Between the Parties

a. One-Way License

This can be applied to an exemplary licensing scenario in which no licensing history exists between the parties and the transaction is a one-way license from one party to the other. Under this scenario, the value of the one-way IP license agreement is determined in accordance with the following.
Contract Value (Kv):
   Kᵥ=K_{IV}×(QF_{R}×R_{EA}/R_{EI})×(QF_{P}×P_{VA}/P_{VI})
where:
K_{IV}=typical industry license value for a similar license (e.g. same field, term, etc.)
QF_{R}=revenue quality factor
R_{EA}=amount of A's exposed revenue
R_{EI}=amount of a typical licensee's exposed revenue (for a similar license)
QF_{P}=patent quality factor
P_{VA}=value A receives from B's patent portfolio
P_{VI}=value a typical licensee receives from a typical patent portfolio (for a similar license)

K_{IV} may be calculated in a number of ways. In general, K_{IV} should be based upon the values of other licenses which are substantially similar to the one under consideration. Fields such as term, business segments, field of license or other fields that are recorded in the License Database may be used to filter irrelevant license agreements. K_{IV} thus represents the typical value of a license which is substantially similar to the one under consideration. Quality factors are as discussed above.

In this example, industry financial and IP data which are substantially related to the license under consideration may be obtained by filtering both the financial and IP databases in a similar fashion as previously explained with the license database. In addition, data contained in both the financial and IP databases relate to the specific license under consideration (e.g. A's exposed revenue and B's patent portfolio data). All data are then analyzed to determine R_{EA}, R_{EI}, P_{VA} and P_{VI}. These four variables may be determined using a number of means, some of which are summarized below. These calculations may be based on historical data stored in the financial and IP databases, forward-looking data based on financial and IP projections, or a combination of both. For the examples below, only historical data are used. The ratios R_{EA}/R_{EI}, and P_{VA}/P_{VI} represent a measurement of how one party's exposed revenue and patent portfolio compare to the other party's (or typical licensee's), respectively. If R_{EA}/R_{EI}>1, party A is in a weaker negotiating position as compared to a typical licensee because party A has more revenue exposed than does the typical licensee. If R_{EA}/R_{EI}<1, party A is in a stronger position as compared to a typical licensee because party A has less revenue exposed than does the typical licensee. Likewise, if P_{VA}/P_{VI}>1, party A is in a weaker negotiating position as compared to a typical licensee because party A receives greater benefit from B's patent portfolio than does the typical licensee. If P_{VA}/P_{VI}<1, party A is in a stronger position as compared to a typical licensee because party A receives less benefit from B's patent portfolio than does the typical licensee. K_{V} is then determined by modifying K_{IV} by R_{EA}, R_{EI}, P_{VA} and P_{VI}. Additionally, R_{EA}, R_{EI}, P_{VA} and P_{VI} may be determined for each geographic region indicated in the Financial and IP Databases (geography weighting). Similarly, R_{EA}, R_{EI}, P_{VA} and P_{VI} may be determined by a number of means as exemplified below. Several types of calculations will be provided below as a way to illustrate the different methods that can be used for calculating different components of the Valuation Function for a one-way license scenario.

The first of these methods is the “Simple Ratios Method”. Under this method, the ratio of R_{EA} to R_{EI} is determined based on the amount by which A's total exposed revenue is either above or below that of a typical licensee's for some period of time T. For example, A may have generated $7 B (billion) of total exposed revenue during T while a typical licensee may have generated $15 B of total exposed revenue during the same period of time. Thus, R_{EA}/R_{EI} is 0.47 ($7 B/$15 B). Similarly, this technique is applied to both B's IP portfolio and a typical licensor's IP portfolio to determine P_{VA}/P_{VI}. For example, B may have been issued 2100 patents during T and a typical licensor may have been issued 2500 patents during the same period of time. Thus, P_{VA}/P_{VI} is 0.84 (2100/2500).

Therefore:
K_{V}=K_{IV}×(QF_{R}×R_{EA}/R_{EI})×(QF_{P}×P_{VA}/P_{VI}), or K_{V}=$10 M×0.47×0.84=$3.9 M (million).

In addition, financial and IP projections may also be factored into this approach. They may be substituted for the historical financial and IP data or used in addition to it. One skilled in the art will recognize how to add or substitute these projections in the analysis.

A second method is referred to as the “Simple Change Method”. Under this method R_{EA}/R_{EI} is determined by generating a ratio which represents the amount by which A's exposed revenue changed over some time period T as compared to the change of a typical licensee's exposed revenue for the same period of time. For example, A may have a change of $3 B in exposed revenue ($2 B to $5 B) during T while a typical licensee may have a change of $5 B in exposed revenue ($5 B to $10 B) during the same period of time. Thus, R_{EA}/R_{EI} is 0.6 ($3 B/$5 B). Similarly, this technique is applied to both B's IP portfolio and a typical licensor's IP portfolio to determine P_{VA}/P_{VI}. For example, B may have an increase of 100 patents (1000 to 1100) during T while a typical licensee may have a decrease of 100 patents (1300 to 1200). Thus, P_{VA}/P_{VI} is 2.0 (200/100).

Therefore,
K_{V}=K_{IV}×(QF_{R}×R_{EA}/R_{EI})×(QF_{P}×P_{VA}/P_{VI}), or K_{V}=$10 M×0.6×2.0=$12.0 M.

In addition, financial and IP projections may also be factored into this approach. They may be substituted for the historical financial and IP data or used in addition to it. One skilled in the art will recognize how to add or substitute these Projections in the analysis.

A third method is referred to as “Weighted Change Method” where R_{EA}/R_{EI} is determined by generating a ratio which represents the amount by which the change in A's exposed revenue during period Tis either above or below that of a typical licensee's for the same period of time, where the change in A's exposed revenue is weighted by the total exposed revenue of both parties. For example, A may have a change of $3 B in exposed revenue ($2 B to $5 B) during T while a typical licensee may have a change of $5 B in exposed revenue ($5 B to $10 B) during the same period of time. Thus, R_{EA}/R_{EI} is 1.18 (($5 B/$15 B/($2 B/$7 B), where $5 B/$15 B is the ratio of A's exposed revenue to the total revenue of both parties at the end of T and $2 B/$7 B is the ratio of A's exposed revenue to the total revenue of both parties at the beginning of T. The Weighted Change Method is most appropriate in cases where the negotiating parties have a large difference in exposed revenue. Weighting the exposed revenue of each party by the total exposed revenue of both parties enables the negotiating parties to account for the positions of both parties relative to each other at the beginning of period T and to use that initial position of the parties when determining the benefit that would be derived under a new license agreement. Similarly, this technique is applied to both B's IP portfolio and a typical licensor's IP portfolio to determine P_{VA}/P_{VI}. For example, B may have an increase of 100 patents (1000 to 1100) during T while a typical licensee may have a decrease of 100 patents (1300 to 1200). Thus, P_{VA}/P_{VI} is 1.10 ((1100/2300/(1000/2300)).

Therefore:
K_{V}=K_{IV}×(QFR×R_{EA}/R_{EI})×(QFP×P_{VA}/P_{VI}), or K_{V}=$10 M×1.18×1.10=$12.98 M.

In addition, Financial and IP Projections may also be factored into this approach. They may be substituted for the historical financial and IP data or used in addition to it. One skilled in the art will recognize how to add or substitute these Projections in the analysis.

Another method that can be used may be referred to as the “Last Point in Time Method’. Under this method R_{EA}/R_{EI} is determined by generating a ratio which represents the amount by which A's exposed revenue at the end of period T is either above or below that of a typical licensee's for the same point in time. Thus, changes over time are not accounted for. For example, A may have $5 B in most recent exposed revenue while a typical licensee may have $10 B. Thus, R_{EA}/R_{EI} is 0.5 ($5 B/$10 B). Similarly, this technique is applied to both B's IP portfolio and a typical licensor's IP portfolio to determine P_{VA}/P_{VI}. For example, B may have 1100 patents at the end of period T while a typical licensee may have 1200 for the same point in time. Thus, P_{VA}/P_{VI} is 0.92 (1100/1200).

Therefore:
K_{V}=K_{IV}×(QF_{R}×R_{EA}/R_{EI})×(QF_{P}×P_{VA}/P_{VI}), or K_{V}=$10 M×0.5×0.92=$4.6 M.

In addition, financial and IP projections may also be factored into this approach. They may be substituted for the historical financial and IP data or used in addition to it. One skilled in the art will recognize how to add or substitute these Projections in the analysis.

A final method that will be discussed is referenced as the “Last Point in Time (Revenue) & Weighted Change (Patents) Method”. This method combines portions of the last point in time and weighted change methods. The last point in time method is the preferred means for determining R_{EA}/R_{EI} because revenue may change rapidly year-to-year and business decisions may be made which severally impact exposed revenue (acquisitions and/or divestitures). The weighted change method is preferred for determining P_{VA}/P_{VI} because an IP portfolio requires much time to develop; and therefore, is generally more stable over longer periods of time. Using this method, R_{EA}/R_{EI} is determined by generating a ratio which represents the amount by which A's most recent exposed revenue is either above or below that of a typical licensee's for the same point in time. For example, A may have $5 B in most recent exposed revenue while a typical licensee may have $10 B. Thus, R_{EA}/R_{EI} is 0.5 ($5 B/$10 B). P_{VA}/P_{VI} is determined by generating a ratio which represents the amount by which B's weighted change in issued patents is either above or below that of a typical licensee's for the same period of time. For example, B may have an increase of 100 patents (1000 to 1100) during T while a typical licensee may have a decrease of 100 patents (1300 to 1200). Thus, P_{VA}/P_{VI} is 1.10 ((1100/2300/(1000/2300)).

Therefore:
K_{V}=K_{IV}×(QFR×R_{EA}/R_{EI})×(QFP×P_{VA}/P_{VI}), or K_{V}32 $10 M×0.5×1.10=$5.5 M.

In addition, Financial and IP Projections may also be factored into this approach. They may be substituted for the historical financial and IP data or used in addition to it.

As previously mentioned, R_{EA}/R_{EI} and P_{VA}/P_{VI} may be determined for multiple geographic regions depending on the licensee's source of revenue generation and the licensor's IP portfolio. Each change in calculation is weighted by the revenue contribution from the respective geographic region (W_{Gn} is the exposed revenue for geographic region n and Wₜₒₜₐₗ is the total exposed revenue for all geographic regions).

Contract Value (Kv):
Kᵥ=K_{IV}×(W_{G1}/W_{Total}×R_{EAG1}/R_{EIG1}+ . . . +W_{Gn}/W_{Total}×R_{EAGn}/R_{EIGn})×(W_{G1}/W_{Tota}l×P_{VAG1}/P_{VIG1}+ . . . +W_{Gn}/W_{Total}×P_{VAGn}/P_{VIGn})
b. Cross-License.

Under the second sub-scenario, when a cross-license is anticipated instead of a one-way license, the value of an IP cross-license agreement where the parties do not have prior licensing experience between them can be determined as follows:

Contract Value (Kv):
Kᵥ=K_{IV}×{[(QF_{R}×R_{EA})×(QF_{P}×P_{VA})]−[(QF_{R}×R_{EB})×(QF_{P}×P_{VB})]}
Where:
K_{IV}=typical industry license value for a similar license (e.g. same field, term, etc.)
QF_{R}=revenue quality factor
R_{EA}=amount of A's exposed revenue
R_{EB}=amount of B's exposed revenue
R_{EI}=amount of a typical licensee's exposed revenue (for a similar license)
QF_{P}=patent quality factor
P_{VA}=value A receives from B's patent portfolio
P_{VB}=value B receives from A's patent portfolio
P_{VI}=value a typical licensee receives from a typical patent portfolio (for a similar license)

K_{IV} may be calculated as previously stated. Industry financial and IP data which is substantially related to the license under consideration may be utilized, as previously stated. Also contained in both the financial and IP databases are data relating to the license under consideration (e.g. A & B's exposed revenue and A's & B's patent portfolio data). In the case of a cross-license, both A's and B's exposed revenue and IP portfolios are analyzed with respect to typical industry data representing a substantially similar license. All data are analyzed to determine R_{EA/B}, R_{EI}, P_{VA/B} and P_{VI}. These four variables may be determined using the same means as previously described. These calculations may be based on historical data stored in the Financial and IP databases, forward-looking data based on financial and IP projections, or a combination of both. For the examples below, historical data is used. K_{V} is determined by modifying K_{IV} by R_{EA/B}, R_{EI}, P_{VA/B} and P_{VI}. Additionally, R_{EA/B}, R_{EI}, P_{VA/B} and P_{VI} may be determined for each geographic region indicated in the Financial and IP databases (geography weighting).

The ratios R_{EA/B} and P_{VA/B} represent a measurement of how one party's exposed revenue and patent portfolio compare to the other party's (or typical licensee's), respectively. If R_{EA}/R_{EB}>1, party A is in a weaker negotiating position as compared to party B because party A has more revenue exposed than does party B. If R_{EA}/R_{EB}<1, party A is in a stronger position as compared to party B because party A has less revenue exposed than does party B. Likewise, if P_{VA}/P_{VB}>1, party A is in a weaker negotiating position as compared to party B because party A receives greater benefit from B's patent portfolio than B does from A's patent portfolio. If P_{VA}/P_{VB}<1, party A is in a stronger position as compared to party B because party A receives less benefit from B's patent portfolio than B does from A's patent portfolio. R_{EA/B}, R_{EI}, P_{VA/B} and P_{VI} may be determined by a number of means, as exemplified below. As before, in the case of one-way license, several similar methodologies can be employed to determine the Valuation Function for a cross-license scenario.

The first method, similar to the previous case will be the “Simple Ratios Method” under which R_{EA}/R_{EI} is determined by generating a simple ratio which represents the amount by which A's total exposed revenue is either above or below that of a typical licensee's for some period of time T. R_{EB}/R_{EI} is determined in a similar fashion, except it represents the amount by which B's total exposed revenue is either above or below that of a typical licensee's. For example, A may have generated $7 B of exposed revenue ($2 B to $5 B) and B $20 B ($15 B to $20 B) during T while a typical licensee may have generated $15 B of exposed revenue ($5 B to $10 B) during the same period of time. Thus, R_{EA}/R_{EI} is 0.47 ($7 B/$15 B) and R_{EB}/R_{EI} is 1.33 ($20 B/$15 B). Similarly, this technique is applied to B's IP portfolio, A's IP portfolio and a typical licensor's IP portfolio to determine P_{VA}/P_{VI} and P_{VB}/P_{VI}. Assume, for example, that B is issued 2100 patents (1000 to 1100) during T and A 1200 patents (400 to 800) while a typical licensor is issued 2500 patents (1300 to 1200) during the same period of time. Thus, P_{VA}/P_{VI} is 0.84 (2100/2500) and P_{VB}/P_{VI} is 0.48 (1200/2500).

Therefore:
K_{V}=K_{IV}×{[(QF_{R}×R_{EA}/R_{EI})×(QF_{P}×P_{VA}/P_{VI})]−[(QF_{R}×R_{EB}/R_{EI})×(QF_{P}×P_{VB}/P_{VI})]}, or K_{V}=$10 M×{[0.47×0.84]−[1.33×0.48]}=$2.4 M (B pays A)

In addition, financial and IP projections may also be factored into this approach. They may be substituted for the historical financial and IP data or used in addition to it. One skilled in the art will recognize how to add or substitute these Projections in the analysis.

A second methodology will be the “Simple Change Method” where R_{EA}/R_{EI} is determined by generating a ratio which represents the amount by which A's exposed revenue changed over some time period T as compared to that of a typical licensee's for the same period of time. R_{EB}/R_{EI} is determined in a similar fashion, except it represents the amount by which B's exposed revenue changed over some time period T as compared to that of a typical licensee's. For example, A may have generated $7 B of exposed revenue ($2 B to $5 B) and B $20 B ($15 B to $20 B) during T while a typical licensee may have generated $15 B of exposed revenue ($5 B to $10 B) during the same period of time. Thus, R_{EA}/R_{EI} is 0.6 ($3 B/$5 B) and R_{EB}/R_{EI} is 1.0 ($5 B/$5 B). Similarly, this technique is applied to B's IP portfolio, A's IP portfolio and a typical licensor's IP portfolio to determine P_{VA}/P_{VI} and P_{VB}/P_{VI}. For example, B may have been issued 2100 patents (1000 to 1100) during T and A 1200 patents (400 to 800) while a typical licensor may have been issued 2500 patents (1300 to 1200) during the same period of time. Thus, P_{VA}/P_{VI} is 2.0 (200/100) and P_{VE}/P_{VI} is 5.0 (500/100).

Therefore:
K_{V}=K_{IV}×{[(QF_{R}×R_{EA}/R_{EI})×(QF_{P}×P_{VA}P_{VI})]−[(QF_{R}×R_{EB}/R_{EI})×(QF_{P}×P_{VB}/P_{VI})]}, or K_{V}=$10 M×{[0.6×2.0]−[1.0×5.0]}=$38 M (B pays A).

In addition, financial and IP projections may also be factored into this approach. They may be substituted for the historical financial and IP data or used in addition to it. Yet a third methodology that can be employed as before is the “Weighted Change Method” where R_{EA}/R_{EI} is determined by generating a ratio which represents the amount by which A's change in exposed revenue during T, where the change in A's exposed revenue is weighted by the total exposed revenue of both parties, is either above or below that of a typical licensee's for the same period of time. R_{EB}/R_{EI} is determined in a similar fashion, except it represents the amount by which B's change in exposed revenue during T, where the change in B's exposed revenue is weighted by the total exposed revenue of both parties, is either above or below that of a typical licensee's for the same period of time. For example, A may have generated $7 B of exposed revenue ($2 B to $5 B) and B $20 B ($15 B to $20 B) during T while a typical licensee may have generated $15 B of exposed revenue ($5 B to $10 B) during the same period of time. Thus, R_{EA}/R_{EI} is 1.18 (($5 B/$15 B)/($2 B/$7 B), where $5 B/$15 B is the ratio of A's exposed revenue to the total revenue of both parties at the end of period T and $2 B/$7 B is the ratio of A's exposed revenue to the total revenue of both parties at the beginning of T) and R_{EB}/R_{EI} is 0.89 (($20 B/$30 B)/($15 B/$20 B), where $20 B/$30 B is the ratio of B's exposed revenue to the total revenue of both parties at the end of period T and $15 B/$20 B is the ratio of B's exposed revenue to the total revenue of both parties at the beginning of T). Similarly, this technique is applied to B's IP portfolio, A's IP portfolio and a typical licensor's IP portfolio to determine P_{VA}/P_{VI} and P_{VB}/P_{VI}. For example, B may have been issued 2100 patents (1000 to 1100) during T and A 1200 patents (400 to 800) while a typical licensor may have been issued 2500 patents (1300 to 1200) during the same period of time. Thus, P_{VA}/P_{VI} is 1.10 ((1100/2300)/(1000/2300)) and P_{VB}/P_{VI} is 2.16 ((800/1200)/(400/1300)).

Therefore:
K_{V}=K_{IV}×{[(QF_{R}×R_{EA}/R_{EI})×(QF_{P}×P_{VA}/P_{VI})]−[(QF_{R}×R_{EB}/R_{EI})×(QF_{P}×P_{VB}/P_{VI})]}, or K_{V}=$10 M×{[1.18×1.10]−[0.89×2.16]}=$6.2 M (B pays A)

In addition, financial and IP projections may also be factored into this approach. They may be substituted for the historical financial and IP data or used in addition to it. The “Last Point in Time Method” can also be employed. Under this method, R_{EA}/R_{EI} is determined by generating a ratio which represents the amount by which A's exposed revenue at the end of period T is either above or below that of a typical licensee's for the same point in time. R_{EB}/R_{EI} is determined in a similar fashion, except it represents the amount by which B's exposed revenue at the end of period T is either above or below that of a typical licensee's. For example, A may have $7 B in most recent exposed revenue and B $20 B during T while a typical licensee may have generated $15 B of most recent exposed revenue during the same period of time. Thus, R_{EA}/R_{EI} is 0.33 ($5 B/$15 B) and R_{EB}/R_{EI} is 1.33 ($20 B/$15 B). Similarly, this technique is applied to B's IP portfolio, A's IP portfolio and a typical licensor's IP portfolio to determine P_{VA}/P_{VI} and P_{VB}/P_{VI}. For example, B may have been issued 2100 patents (1000 to 1100) during T and A 1200 patents (400 to 800) while a typical licensor may have been issued 2500 patents (1300 to 1200) during the same period of time. Thus, P_{VA}/P_{VI} is 0.92 (1100/1200) and P_{VB}/P_{VI} is 0.67 (800/1200).

Therefore:
K_{V}=K_{IV}×{[(QF_{R}×R_{EA}/R_{EI})×(QF_{P}×P_{VA}/P_{VI})]−[(QF_{R}×R_{EB}/R_{EI})×(QF_{P}×P_{VB}/P_{VI})]}, or K_{V}=$10 M×{[0.33×0.92]−[1.33×0.67]}=$5.9 M (B pays A).

In addition, financial and IP Projections may also be factored into this approach. They may be substituted for the historical financial and IP data or used in addition to it.

A final methodology that can be employed is the “Last Point in Time (Revenue) & Weighted Change (Patents) Method” as before. As mentioned earlier, this method combines portions of the last point in time and weighted change methods. The last point in time method is the preferred means for determining R_{EA}/R_{EI} because revenue may change rapidly year-to-year and business decisions may be made which severally impact exposed revenue (acquisitions and/or divestitures). The weighted change method is preferred for determining R_{VA}/P_{VI} because an IP portfolio requires much time to develop and, therefore, is generally more stable over longer periods of time.

Using this method, R_{EA}/R_{EI} is determined by generating a ratio which represents the amount by which A's most recent exposed revenue is either above or below that of a typical licensee's for the same point in time. R_{EB}/R_{EI} is determined in a similar fashion, except it represents the amount by which B's most recent exposed revenue is either above or below that of a typical licensee's. For example, A may have generated $5 B of most recent exposed revenue and B $20 B while a typical licensee may have generated $15 B of most recent exposed revenue. Thus, R_{EA}/R_{EI} is 0.33 ($5 B/$15 B) and R_{EB}/R_{EI} is 1.33 ($20 B/$15 B).

The weighted change technique is applied to B's IP portfolio, A's IP portfolio and a typical licensor's IP portfolio to determine P_{VA}/P_{VI} and P_{VB}/P_{VI}. For example, B may have been issued 2100 patents (1000 to 1100) during T and A 1200 patents (400 to 800) while a typical licensor may have been issued 2500 patents (1300 to 1200) during the same period of time. Thus, P_{VA}/P_{VI} is 1.10 ((1100/2300)/(1000/2300)) and P_{VB}/P_{VI} is 2.16 ((800/1200)/(400/1300)).

Therefore:
K_{V}=K_{IV}×{[(QF_{R}×R_{EA}/R_{EI})×(QF_{P}×P_{VA}P_{VI})]−[(QF_{R}×R_{EB}/R_{EI})×(QF_{P}×P_{VB}/P_{VI})]}, or K_{V}=$10 M×{[0.33×1.10]−[1.33×2.16]}=$25 M (B pays A).
In addition, financial and IP projections may also be factored into this approach. They may be substituted for the historical financial and IP data or used in addition to it.
2. Licensing History Exists Between the Parties

The foregoing analyses of scenarios involving no prior licensing history between the parties may certainly be used to determine the value of a contract when there is a prior history. However, it is preferred to directly compare the two parties' data over time and scale the value of the contract accordingly, instead of merely comparing each party's data to typical industry data. This discussion will also take into account the two sub-categories of one-way licensing and a cross-license.

a. One-Way License

The value of a one-way IP license agreement where the parties have prior licensing experience between them is determined as follows:

New Contract Value (Kₙᵥ):
Kₙᵥ=Kₚᵥ×[(W_{G1}/Wₜₒₜₐₗ×R_{G1-licensee}×P_{G1-licensor})+ . . . +(W_{Gn}/Wₜₒₜₐₗ×R_{Gn-licensee}×_{PGn-licensor})]_{licensee}
Note that the change in the last statement above determines the change in benefits to the licensee.

The new contract value (Kₙᵥ) is determined by scaling the previous contract value (Kₚᵥ) by the change in benefit received (R_{G-licensee}×P_{G-licensor}) under the previous licensee. If the benefit received by the licensee decreased during the period of the previous contract, the renewal contract value will be scaled down. Alternately, if the benefit received by the licensee increased during that period, the renewal contract value will be scaled up to reflect the additional benefit received. Additionally, the change in benefit received can be determined by each geographic region from which the licensee obtains revenue and in which the licensor owns and maintains IP. In its simplest form, change in benefit received (R_{G-licensee}×P_{G-licensor}) is determined by multiplying the licensee's change in exposed revenue (R_{G-licensee}) by the licensor's change in IP portfolio strength (P_{G-licensor}). The licensee's exposed revenue is that portion of the licensee's total revenue which is covered by (or benefits from) from the licensor's IP portfolio. The licensor's IP portfolio is that portion of the licensor's total IP portfolio which covers (or provides benefit to) the licensee's exposed revenue. The change is determined over some term. The term may be an agreed to number (e.g. the past five years), may be the term of the previous contract (e.g. 1993-2003), or any other amount of time. The change in licensee's exposed revenue (R_{G-licensee}) and licensor's change in IP portfolio strength (P_{G-licensor}) may be determined by a number of different methods.

Under the first method, referred to as the “Ratios Method”, the change in a licensee's exposed revenue is determined by generating a ratio which represents the values of exposed revenue at two end points of the term. For example, the licensee may have generated $10 M of exposed revenue at the earlier point and $12 M and the later point. Thus, R_{G-lincensee} would be 1.2 ($12 M/$10 M). Similarly, this ratio technique is applied to the licensor's IP portfolio. For example, the licensor may have been issued 100 patents during the earlier point and 120 patents during the later point. Thus, P_{G-licensor} would be 1.2 (120/100). Therefore, the change in benefit received by the licensee from the licensor's IP portfolio over the specified term would be a factor of 1.44 (1.2×1.2).

Under the second method, referred to as the “Averages Method”, the change in licensee's exposed revenue is determined by generating an average which represents the average change in exposed revenue over the specified term. For example, the licensee may have averaged a 5% increase in revenue during the specified term. Thus, R_{G-licensee} would be 1.05. Similarly, this average technique is applied to the licensor's patent portfolio. For example, the licensor may have averaged a 10% increase of patents during the specific term. Thus, P_{G-licensor} would be 1.1. Therefore, the change in benefit received by the licensee from the licensor's IP portfolio over the specified term would be a factor of 1.15 (1.05×1.1).

A third method, referred to as the “Revenue Ratio/Patent Average Method” can also be employed. This method combines portions of the ratio and average methods. The ratio method is the preferred means for analyzing the change in exposed revenue because revenue may change rapidly year-to-year and business decisions may be made which severally impact exposed revenue (acquisitions and/or divestitures). An alternate approach would be to use a weighted average model. The average method is preferred for determining the change in IP portfolio strength because an IP portfolio requires much time to develop; and therefore, is generally more stable over longer periods of time. Alternately, a weighted average model could be used to determine the change in IP portfolio strength.

The change in a licensee's exposed revenue is determined by generating a ratio which represents the values of exposed revenue at two end points of the term. For example, the licensee may have generated $10 M of exposed revenue at the earlier point and $12 M and the later point. Thus, R_{G-licensee} would be 1.2 ($12 M/$10 M). Similarly, the average technique is applied to the licensors patent portfolio. For example, the licensor may have averaged a 10% increase of patents during the specific term. Thus, P_{G-licensor} would be 1.1. Therefore, the change in benefit received by the licensee from the licensors IP portfolio over the specified term would be a factor of 1.32 (1.2×1.1).

As previously mentioned, the change in benefit analysis may be done for multiple geographic regions depending on the licensee's source of revenue generation and the licensor's IP portfolio. Each change in benefit calculation is weighted by the revenue contribution from the respective geographic region (W_{Gn} is the exposed revenue for geographic region n and Wₜₒₜₐₗ is the total exposed revenue for all geographic regions).

b. Cross-License

In the second sub-scenario, the value of an IP cross-license agreement, where the parties have prior licensing experience between them, is determined as follows for the case of a cross-license negotiation:

New Contract Value (Kₙᵥ):
Knv=Kpv×{1+[(W_{G1}/Wₜₒₜₐₗ×_{RG1-licensee}×P_{G1-licensor})+ . . . +(W_{Gn}/Wₜₒₜₐl×R_{Gn-licensee}×_{PGn-licensor})]_{licensee}−[(W_{G1}/Wₜₒₜₐₗ×R_{G1-licensor}×P_{G1-lincensee})+ . . . +(W_{Gn}/Wₜₒₜₐₗ×R_{Gn-licensor}×P_{Gn-licensee})]_{licensor}}
Whereas the first part of:
[(W_{G1}/Wₜₒₜₐₗ×_{RG1-licensee}×P_{G1-licensor})+ . . . +(W_{Gn}/Wₜₒₜₐl×R_{Gn-licensee}×_{PGn-licensor)]}_{licensee}
describes the benefit to the licensee and the second part of
[(W_{G1}/Wₜₒₜₐₗ×R_{G1-licensor}×P_{G1-licensee})+ . . . +(W_{Gn}/Wₜₒₜₐₗ×R_{Gn-licensor}×P_{Gn-licensee})]_{licensor}}
describes the benefit to the licensor.

Under this scenario, both parties receive benefit under a cross-license. Therefore, the renewal contract value is scaled by the difference between: the change in benefit received by A (payor) under party B's (payee) IP portfolio and the change in benefit received by B under party A's IP portfolio.

In the case where there is no change in benefit received by both parties or where the benefit scales identically (change in benefit to A minus the change in benefit to B=0), the net effect is the renewal contract value equals the previous contract value. Of course, the benefit can be scaled for economic conditions such as inflation.

If the benefit received by the paying party (party A) increased more than the benefit received by B over the specified term, then the renewal contract value is scaled up by the net benefit received by A (change in benefit of A change in benefit to B>1) and will be worth more than the previous contract value.

If the benefit received by the paying party (party A) increased less than the benefit received by B over the specified term, then the renewal contract value is scaled down by the net benefit received to B (change in benefit of A minus the change in benefit to B<0>−1) and will be worth less than the previous contract value. If A's benefit decreases enough or if B's increases enough, B may be the one who has to pay (for example, where the change in benefit to A minus the change in benefit to B<−1).

Outputs and Feedback

As described in the foregoing, systems and methods are provided for valuing IP, especially in terms of respective contributions to the transaction by the parties, and in relation to previous transactions, especially previous one-way or cross-license agreements between the parties. During the negotiation of an IP transaction such as a license agreement, the parties will want to verify that the valuations and Trend Function values that result from the above-described tools are based on solid factual data and correct assumptions. Accordingly, when conducting valuations using the foregoing tools, assumptions and factual bases such as the above-described quality factors are checked adjusted as often and as much as needed. In such manner, a valuation can be provided to the other party to the negotiation, together with all of the assumptions and facts on which it is based, as a way of demonstrating that a correct valuation has been achieved.

While the invention has been described in accordance with certain preferred embodiments thereof, those skilled in the art will understand the many modifications and enhancements which can be made thereto without departing from the true scope and spirit of the invention, which is limited only by the claims appended below.

1. A method of valuing an intellectual property (IP) collection of a first party in a transaction involving a grant by the first party of at least one of rights and immunities to a second party, comprising:
a) estimating an amount of revenue of the second party to which the IP collection is deemed to apply; and
b) placing a value on the IP collection based on the estimated amount of revenue and information including one or more of the following:
i) IP trend factor based on a change in the IP collection,
ii) revenue trend factor based on change in revenue of the second party to which the IP collection is deemed to apply, and change in revenue of one or more entities having revenue in the same industry as the second party,
iii) type of industry to which the IP collection applies,
iv) prior licensing data involving the IP collection, and
v) IP and revenue quality factors.

2. A method as claimed in claim 1, wherein the IP collection is divided into subcollections based on subject matter, and said steps a) and b) are performed with respect to each of said subcollections.

3. A method as claimed in claim 1, wherein the IP collection is divided into subcollections based on the country in which the IP is held, and said steps a) and b) are performed with respect to each of said subcollections.

4. A method as claimed in claim 1, wherein the IP collection is divided into subcollections based on the country in which the applicable revenue is generated, and said steps a) and b) are performed with respect to each of said subcollections.

5. A method as claimed in claim 1, wherein the value placed on the IP collection is adjusted in accordance with a “simple ratios method”.

6. A method as claimed in claim 1, wherein the value placed on the IP collection is adjusted in accordance with a “weighted change method”.

7. A method as claimed in claim 1, wherein the value placed on the IP collection is adjusted in accordance with a “last point in time method”.

8. A method as claimed in claim 1, wherein the value placed on the IP collection is adjusted in accordance with a “last point in time and weighted change method”.

9. A method of valuing an intellectual property (IP) transaction for licensing a first IP collection of a first party to a second party, and for licensing a second IP collection of the second party to the first party, comprising:
I) placing a value on the first IP collection by dividing the first IP collection into m distinct first subcollections, and for each of the m first subcollections:
a) estimating an amount of revenue of the second party to which the selected first subcollection is deemed to apply, and
b) placing a value on the selected first subcollection based on the estimated amount of revenue and information including one or more of the following:
i) IP trend factor based on a change in at least the first subcollection,
ii) revenue trend factor based on change in revenue of the second party to which the first subcollection is deemed to apply, and change in revenue of one or more entities having revenue in the same industry as the second party,
iii) type of industry to which the selected first subcollection applies,
iv) prior licensing data involving the selected first subcollection, and
v) IP and revenue quality factors;
II) placing a value on the second IP collection by dividing the second IP collection into n distinct second subcollections, and for each of the n second subcollections,
a) estimating an amount of revenue of the first party to which the selected second subcollection is deemed to apply,
b) placing a value on the selected second subcollection based on the estimated amount of revenue and information including one or more of the following:
i) IP trend factor based on a change in at least one of the second subcollection and the second IP collection,
ii) revenue trend factor based on change in revenue of the first party to which the second subcollection is deemed to apply, and change in revenue of one or more entities having revenue in the same industry as the first party,
iii) type of industry to which the selected second subcollection applies,
iv) prior licensing data involving the selected second subcollection, and
v) IP and revenue quality factors; and
III) combining the values placed on the first and second IP collections in steps I and II to determine a relative valuation between the first and second IP collections.

10. A method as claimed in claim 9 wherein the first and second IP collections are divided into the first subcollections and the second subcollections, respectively, based on subject matter.

11. A method as claimed in claim 9 wherein the first and second IP collections are divided into the first subcollections and the second subcollections, respectively, based on the particular country in which the IP is held.

12. A method as claimed in claim 9 wherein the first and second IP collections are divided into the first subcollections and the second subcollections, respectively, based on the particular country in which the applicable revenue is generated.

13. A method as claimed in claim 9, wherein the values placed on the first and second subcollections are adjusted in accordance with a “simple ratios method”.

14. A method as claimed in claim 9, wherein the values placed on the first and second subcollections are adjusted in accordance with a “weighted change method”.

15. A method as claimed in claim 9, wherein the values placed on the first and second subcollections are adjusted in accordance with a “last point in time method”.

16. A method as claimed in claim 9, wherein the values placed on the first and second subcollections are adjusted in accordance with a “last point in time and weighted change method”.

17. A method of determining a value of a current IP transaction, comprising:
providing IP data, financial data, and license data, said license data representing transactions other than the current IP transaction;
obtaining a license value by referring to said license data; and
determining the value of the current IP transaction by adjusting the license value in relation to the IP data, the financial data, and at least one of: i) trend data and ii) at least one quality factor.

18. A method as claimed in claim 17, wherein said trend data includes IP trend data and financial trend data.

19. A method as claimed in claim 17, wherein said at least one quality factor includes a value saturation point.

20. A method as claimed in claim 17, wherein said at least one quality factor is selected from a plurality of quality factors determined based on at least one of: an average number of patents issued during a time period T, an average number of patents filed during T, a cumulative probability distribution function (CDF) of the number of patents issued during T, a CDF of the number of patents filed during T, a weighted average number of patents issued during T, a weighted average number of patents filed during T, a weighted CDF of the number of patents issued during T, and a weighted CDF of the number of patents filed during T.

21. A method as claimed in claim 17, wherein said license value is further adjusted in response to the at least one quality factor.

22. A method as claimed in claim 17, wherein said license value is further adjusted in response to projected data.

23. A method as claimed in claim 17, wherein said license value is further adjusted in response to geographical data.

24. A method as claimed in claim 17, wherein said license value is adjusted in accordance with a “simple ratios method”.

25. A method as claimed in claim 17, wherein said license value is adjusted in accordance with a “weighted change method”.

26. A method as claimed in claim 17, wherein said license value is adjusted in accordance with a “last point in time method”.

27. A method as claimed in claim 17, wherein said license value is adjusted in accordance with a “last point in time and weighted change method”.

28. A method as claimed in claim 17, wherein said license value comprises at least one of a typical industry license value and a previous contract value.

29. A method as claimed in claim 17, wherein said license value is further adjusted in response to a benefit received by each party to said transaction.

30. A method of determining a value of a current IP transaction, comprising:
providing IP data, financial data, and license data, said license data representing transactions other than the current IP transaction;
obtaining a license value by referring to said license data; and
determining the value of the current IP transaction by adjusting the license value in relation to the IP data, the financial data, and at least one of: i) trend data and ii) at least one quality factor.

31. A machine-readable medium having instructions recorded thereon for performing a method of determining a value of a current IP transaction, said method comprising:
providing IP data, financial data, and license data, said license data representing transactions other than the current IP transaction;
obtaining a license value by referring to said license data; and
determining the value of the current IP transaction by adjusting the license value in relation to the IP data, the financial data, and at least one of: i) trend data and ii) at least one quality factor.

32. A system operable to determine a value of a current IP transaction, comprising:
an information processing system operable to obtain a license value by referring to license data representing transactions other than the current IP transaction, and to determine the value of the current IP transaction by adjusting the license value in relation to IP data, financial data, and at least one of: i) trend data and ii) at least one quality factor.
